(19) United States
(12) Patent Application Publication
(10) Pub. No.: US 2019/0184588 A1
(43) Pub. Date: Jun. 20, 2019

(54) WEARABLE CUTTING APPARATUS

(71) Applicant: Black & Decker, Inc., New Britain, CT (US)

(72) Inventors: Brianna Marie Keelan, Charlotte, NC (US); Song Gao, Towson, MD (US); Lauren L. Hudobenko, Middlebury, CT (US); Michael Devino, III, Watertown, CT (US); Mark Evans, Burlington (CA); Jewel Guy, Towson, MD (US); Christian Elder, Baltimore, MD (US); Ryan Peloquin, Ellicott City, MD (US); Igor Sobolevsky, Elkridge, MD (US); Tylan Tschopp, Baltimore, MD (US); Connor Riegle, Towson, MD (US)

(21) Appl. No.: 16/220,366

(22) Filed: Dec. 14, 2018

Related U.S. Application Data
(60) Provisional application No. 62/599,190, filed on Dec. 15, 2017.

(51) Int. Cl. B26B 27/00; B65H 35/00; A41D 19/00

(52) U.S. Cl. CPC B26B 27/007; B26B 27/005; B65H 35/002; A41D 19/0048; A41D 19/0024; A41D 19/0037; A41D 2600/20; B65H 35/008

(57) ABSTRACT

A glove comprises a flexible area configured to be worn on a hand of a user, the flexible area being positioned to be secured on a palm of the hand. The glove also comprises a reinforced area coupled to the flexible area, the reinforced area configured to engage a thumb of the hand and extend towards the palm of the hand. The glove further comprises a protrusion on the reinforced area, the protrusion comprising a blade. The protrusion orients the blade at an angle with respect to the reinforced area.

### CROSS REFERENCE TO RELATED APPLICATIONS

This application claims priority to U.S. Provisional Patent Application No. 62/599,190 filed on Dec. 15, 2017, the contents of which are hereby incorporated by reference into the present application.

### FIELD OF THE INVENTION

The present invention relates generally to packing accessories, and in particular box and tape splitting tools.

### BACKGROUND OF THE INVENTION

Store clerks, warehouse clerks, and others often are repeatedly manipulating boxes and other packages, including relocating the packages, and opening the packages for removal or display of contents.

Among other things, the present application relates to improvements to work gloves and other wearable implements facilitating opening of packaging material.

### SUMMARY OF THE INVENTION

According to an embodiment, a glove comprises a flexible area configured to be worn on a hand of a user, the flexible area being positioned to be secured on a palm of the hand. The glove also comprises a reinforced area coupled to the flexible area, the reinforced area configured to engage a thumb of the hand and extend towards the palm of the hand. The glove further comprises a protrusion on the reinforced area, the protrusion comprising a blade. The protrusion orients the blade at an angle with respect to the reinforced area.

The objects, features, and characteristics of the present invention, as well as the methods of operation and functions of the related elements of structure and the combination of parts and economies of manufacture, will become more apparent upon consideration of the following description with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only, and are not intended as a definition of the limits of the invention. In addition, it should be appreciated that structural features shown or described in any one embodiment herein can be used in other embodiments as well. As used herein, the singular form of “a”, “an”, and “the” include plural referents unless the context clearly dictates otherwise.

### BRIEF DESCRIPTION OF THE DRAWINGS

Features of wearable implements in accordance with one or more embodiments are shown in the drawings, in which like reference numerals designate like elements. The drawings form part of this original disclosure in which:

FIGS. 1A-C illustrate a first embodiment of a box opening glove having a forearm oriented thumb blade;

FIGS. 2A-D illustrate a second embodiment of a box opening glove having a serrated omnidirectional thumb blade;

FIGS. 3A-E illustrate a third embodiment of a box opening glove having grasp engageable thumb and index finger blades;

FIGS. 4A-B illustrate a fourth embodiment of a box opening glove having a fingertip oriented little finger side-palm blade;

FIGS. 5A-E illustrate a fifth embodiment of a box opening glove having a serrated omnidirectional little finger side-palm blade;

FIGS. 6A-D illustrate a sixth embodiment of a box opening glove having a thumb activated retractable little finger side-palm blade;

FIGS. 7A-C illustrate a seventh embodiment of a box opening glove having a serrated omnidirectional interphalangeal joint blade;

FIGS. 8A-D illustrate an eighth embodiment of a box opening glove having a thumb activated retractable index finger blade;

FIGS. 9A-E illustrate a ninth embodiment of a box opening glove having a back of hand mounted tape dispenser;

FIGS. 10A-B illustrate a ring having an interphalangeal joint blade;

FIGS. 11A-C illustrate a hand brace having a little finger side-palm blade;

FIG. 12A-B shows illustrative views of where a thumb blade may be mounted relative to a hand wearing embodiments of gloves of the present disclosure;

FIGS. 13A-B illustrate potential angles for mounting a blade adjacent to or relative to a finger of a hand wearing embodiments of gloves of the present disclosure;

FIG. 14 illustrates potential angles for mounting a blade relative to the side of the palm adjacent to the little finger of a hand wearing embodiments of gloves of the present disclosure; and

FIG. 15 illustrates how an index finger blade may be oriented in some embodiments.

### DETAILED DESCRIPTION OF THE ILLUSTRATED EMBODIMENT(S)

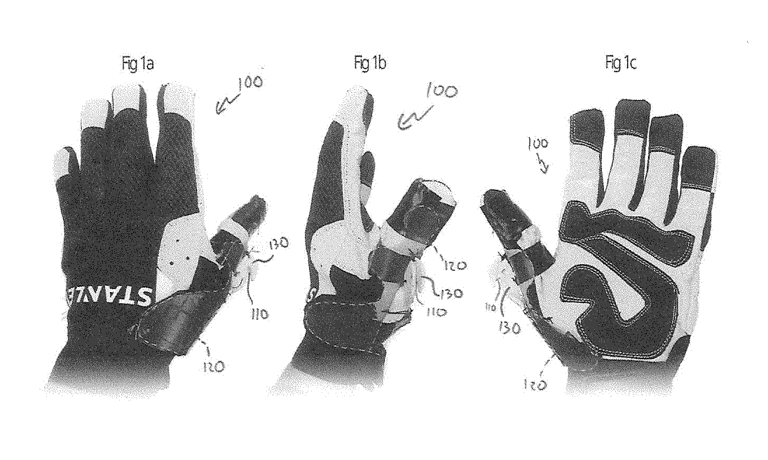

As shown in FIGS. 1a-c, a box opening glove 100 may include a thumb blade 110. As shown in FIG. 1a, the glove 100 may include a reinforced structure 120 in the glove 100 (e.g., a “spine” along the thumb mid-joint, distal from the fingers and palm), which may provide generally rigid support on a generally flexible area of the glove 100. In an embodiment, the reinforced structure 120 may be embedded into or sewn or otherwise fixed onto the glove 100, but may have a protrusion 130 which orients the blade 110 into a desired position. For example, in an embodiment the thumb blade 110 may be mounted as a drag-blade, such that a user holding a package may engage the blade into the packaging, and pull their arm towards themselves to cut the package with the blade 110.

As shown in FIG. 1b, in an embodiment the blade 110 may be mounted at approximately at an angle relative to the thumb of the glove 100. For example, relative to a reference plane defined by a thumbnail of a hand in the glove 100, where at the thumb extending away from the fingers along the plane is taken as 0°, and extending outward from the thumbnail perpendicular to the plane is taken as 90°, it may be appreciated that the blade 110 may be mounted approximately between −10° and 45°. In an embodiment, the blade 110 may be mounted between approximately 25° and 45°. In an embodiment, the blade 110 may be mounted at approximately 35°. In an embodiment, such positioning may optimize balance, comfort, and control of distal movements on thumb exterior while minimizing unwanted blade interactions. As shown in FIG. 1c, in an embodiment the protrusion 130 may include a letter-opener style safety sheath which may limit the size of a substrate that can be exposed to the blade 110, and may guide packaging tape, twine, or plastic ties towards the blade 110.

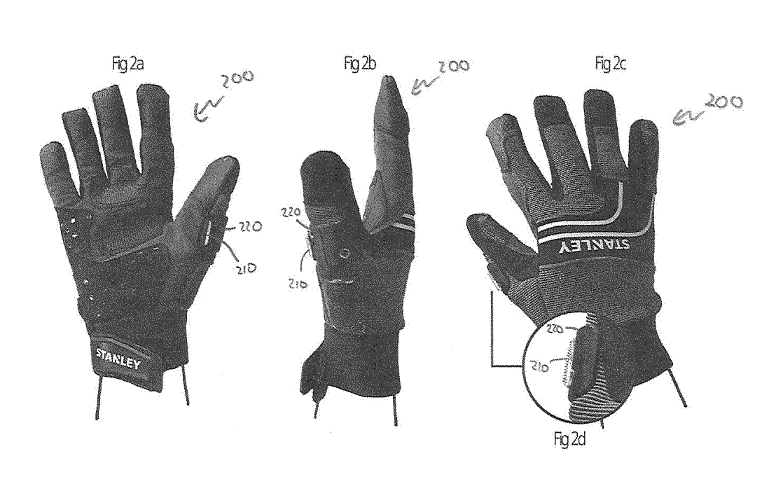

FIGS. 2a-d illustrates a box opening glove 200 having a serrated thumb blade 210. As shown, in an embodiment the glove 200 may include a reinforced structure 220 in the glove 200 (e.g., a “spine” along the thumb mid-joint, distal from the fingers and palm), which may provide generally rigid support on a generally flexible area of the glove 200. In an embodiment, the reinforced structure 220 may be embedded into or sewn or otherwise fixed onto the glove 200, but may be configured to orients the blade 210 into a desired position.

In an embodiment, the blade 210 may be mounted at approximately at an angle relative to the thumb of the glove 200. For example, relative to a reference plane defined by a thumbnail of a hand in the glove 200, where at the thumb extending away from the fingers along the plane is taken as 0°, and extending outward from the thumbnail perpendicular to the plane is taken as 90°, it may be appreciated that the blade 210 may be mounted approximately between −10° and 45°. In an embodiment, the blade 210 may be mounted between approximately 25° and 45°. In an embodiment, the blade 210 may be mounted at approximately 35°. In an embodiment, such positioning may optimize balance, comfort, and control of distal movements on thumb exterior while minimizing unwanted blade interactions. As shown in FIG. 2c, and enlarged in FIG. 2d, in an embodiment the blade 210 may be generally flat with a serrated configuration which may minimize potential for puncture wounds and unintended cuts, and may facilitate utilizing saw-teeth to rip through packaging materials such as strapping tape by utilizing a natural pulling motion. In an embodiment, the blade 210 may be omnidirectionally configured, facilitating either pulling or pushing the blade 210 to cut packaging material.

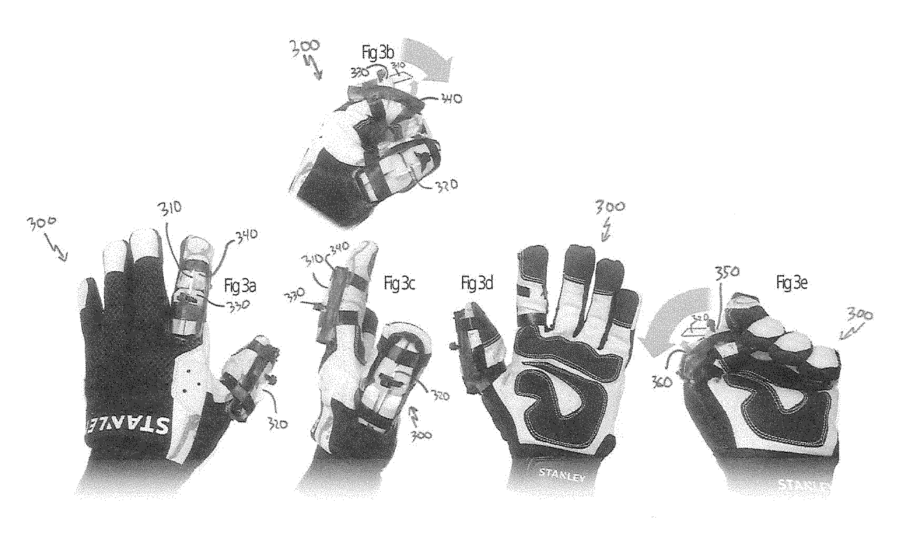

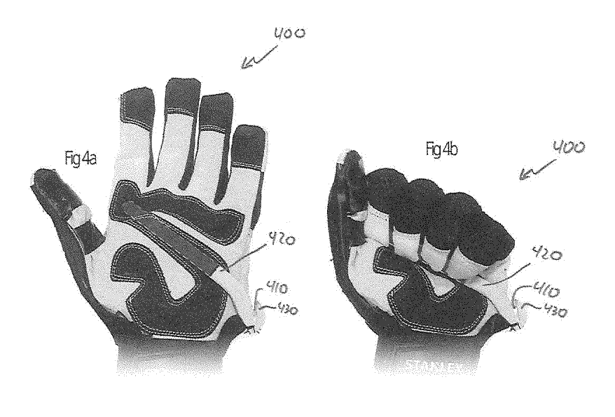

FIGS. 3a-e illustrate another embodiment of a box opening glove. Specifically, box opening glove 300 includes grasp engageable finger blade 310 and grasp engageable thumb blade 320. While the box opening glove 300 includes both blade 310 and blade 320, it may be appreciated that in some embodiments the glove 300 may have either the blade 310 or the blade 320 (and the associated structures disclosed herein) mounted thereon. With regard to embodiments including the finger blade 310, it may be appreciated that in some embodiments finger blade 310 may be fixed by a blade mount 330 relative to the proximal phalanges of the finger, while a protruding portion of the blade 310 may be selectively received in a blade cover 340 fixed relative to the middle and/or distal phalanges of the finger when the fingers are extended from the palm. It may be appreciated that in some embodiments the blade cover 340 may form a rigid channel which surrounds at least the sharpened portions of the blade 310 (e.g., channeled plates forming a grove in between which the blade 310 may selectively be received based on extension or contraction of the fingers). As shown in FIG. 3b, when the fingers are curled into the palm, a protruding portion of the blade 310 may extend forward of the middle and distal phalanges, as these finger portions and the blade cover 340 fixed thereto are pulled away from the blade 310. In other embodiments, the finger blade 310 may be fixed relative to the middle phalanges of the finger, while the blade cover 340 may be fixed relative to the distal phalanges of the finger.

As shown in FIG. 3e, in an embodiment the blade 320 may be fixed to the distal phalanx, e.g., by a blade mount 350, while a protruding portion of the blade 320 may be configured to be selectively received in a blade cover 360 (e.g., channeled plates forming a grove in between which the blade 320 may selectively be received based on extension or contraction of the thumb relative to the palm). Accordingly, by pulling the thumb towards the palm, the blade 320 may extend out of the blade cover 360, and be exposed. It may be appreciated that in other embodiments, the blade 320 may be fixed relative to either the proximal phalanx or the distal interphalangeal joint associated with the thumb, and again may be exposed in a desired manner through movement of the thumb relative to the palm. It may further be appreciated that in some embodiments the blade 310 or the blade 320 may be sharpened for facilitating cutting by pulling the hand towards the user, pushing the hand away from the user, or both (e.g., sharpened on opposing sides or to a tip).

FIGS. 4a-b illustrate still another embodiment of a box opening glove 400 having a side-palm blade 410 (e.g., a blade located on the side of the glove 400 adjacent to the palm). As shown, in an embodiment the blade 410 may be mounted on the pinkie side of the glove 400, distal from the thumb, and may in some embodiments be oriented facing the fingertips of the glove 400. In an embodiment, a low-profile channel sewn through the palm of the glove 400 may hold a handle support 420 for the blade 410. In an embodiment, the channel holds the handle 420 tight so as to create a desired pressure and control movement of the blade 410 when not in use. In an embodiment, the blade 410 and handle 420 (together as a knife assembly) may be fixed into the glove 400, while in other embodiments the knife assembly may be removable from the channel, so as to facilitate alternate uses of the knife assembly. In an embodiment, the channel may be oriented on the glove so as to facilitate a desired orientation of the blade 410 relative to the glove 400 when the knife assembly is held in the glove 400. As shown in FIG. 4b, by closing the fingertips around the palm of the glove, a user may squeeze the handle 420 and provide greater rigidity and support to the blade 410. For example, in an embodiment a low-profile offset (from bias) positioning of the blade 410 by the channel and handle 420 configuration outside of Hypothenar muscles may minimize unwanted blade interactions. In an embodiment, the handle 420 or another structure may provide a “letter-opener” style safety hood 430 over the blade 410, limiting an angle or possible amount of blade exposure.

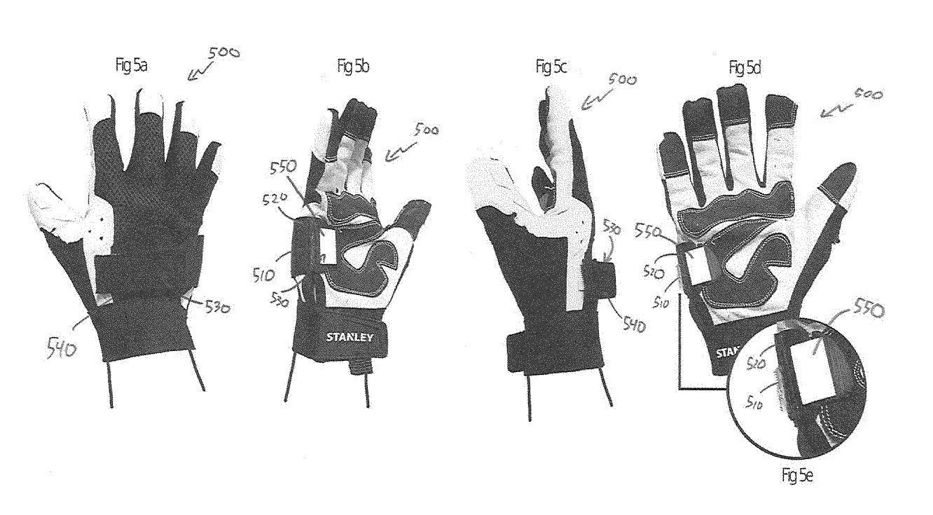

FIGS. 5a-e illustrates another embodiment of a box opening glove 500. As shown, in an embodiment the box opening glove 500 includes a side-palm blade 510 (e.g., a blade located on the side of the glove 500 adjacent to the palm). As further shown, in an embodiment the blade 510 may be a serrated blade, and may facilitate cutting omnidirectionally (e.g., through both pushing and pulling of the glove 500). In an embodiment, the blade 510 may be mounted at approximately along a plane parallel to the extension of the palm, outside of the hypothenar muscles. In an embodiment, where at the hypothenar muscle extending away from the fingers along the plane is taken as 0°, and extending outward from the fingernails perpendicular to the plane is taken as 90°, it may be appreciated that the blade 510 may be mounted approximately between −10° and 45°. In an embodiment, the blade 510 may be mounted between approximately 25° and 45°. In an embodiment, the blade 510 may be mounted at approximately 35°. Accordingly, in an embodiment, such as that illustrated, the blade 510 may be adjacent the little finger side of the glove 500. It may be appreciated that the blade 510 may be mounted in a relatively rigid blade mount 520 which may orient the blade 510 appropriately relative to the remainder of the glove 500. In some embodiments, the glove 500 may include a blade cover 530, which may selectively cover the blade 510 when use is not desired. For example, in the illustrated embodiment the blade cover 530 may include a strap 540 and hook and loop fastener components 550, such that the strap 540 may be positioned over the blade 510 and fixed to the glove 500 with the hook and loop fastener components 550. It may be appreciated that hook and loop fastener components 550 may be positioned so as to secure the strap 540 in either a position with the blade exposed or a position with the blade covered in various embodiments. In various embodiments, either the hooks or the loops may be associated with either the strap 540 or the body of the glove 500. It may be appreciated that in other embodiments one or more magnets and/or corresponding magnetically attractable metal may be utilized instead of or in addition to the hook and loop fastener components 550. In an embodiment, the weighting of the magnet or metal on the strap 540 may facilitate a user flicking their hand so as to disengage or reengage the strap 540 covering the blade 510.

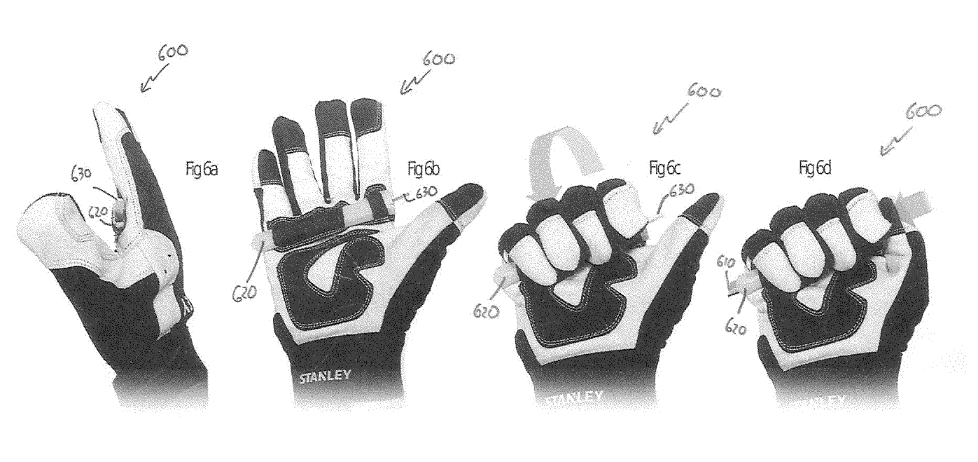

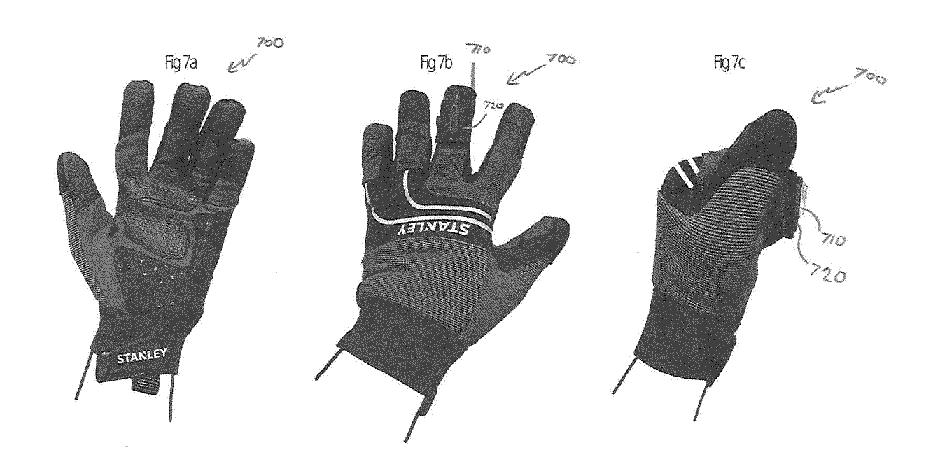

FIGS. 6a-d illustrate a yet another embodiment of a box opening glove 600 having a little finger side-palm blade 610 (e.g., a blade located on the side of the glove 600 adjacent to the palm). As shown in an embodiment the blade 610 may be retractable into a housing 620 which may be sewn into or slidable into a pocket on the glove 600. In an embodiment, the sewn-in orientation or the pocket configuration may be oriented to hold the housing 620 in position when the blade 610 is not in use. As further shown, in an embodiment the housing 620 may include an actuator 630 which may be configured so as to extend the blade 610 when the actuator 630 is depressed. It may be appreciated that in some embodiments the actuator may be on or adjacent to an end of the housing 620 distal from the opening of the housing 620 through which the blade selectively protrudes. In an embodiment, such as that shown, the actuator 630 may be positioned to be actuated by the thumb of a user wearing the glove. Accordingly, in an embodiment the act of making a fist may expose the blade when squeezed. In an embodiment, the blade 610 may include both a safety lock as well as the actuator 630. For example, in an embodiment, the safety lock may be disengaged through the act of bringing the fingers towards palm, which may allow the actuator 630 to be depressed when the user brings the thumb against the actuator 630 to complete the closing of a fist with the glove 600. In some embodiments, the blade 610 may be spring biased into a retracted position, such that maintaining a force on the actuator 630 may be needed to keep the blade 610 in an extended position. In some embodiments, the blade 610 may be replaceable (e.g., the housing 620 may be openable or a secondary actuator may be provided on the housing 620 so as to permit removing and replace the blade from a blade carriage coupled to the actuator 630, for example).

Another embodiment is illustrated in FIGS. 7a-c, where a box opening glove 700 includes an interphalangeal joint blade 710. As shown, in an embodiment the blade 710 may be located on the middle finger of the glove 700. In an embodiment the blade 710 may be mounted to a generally rigid blade support 720 which may be sewn into the glove 700, and may orient the blade 710 at a desired angle. In an embodiment, the blade 710 may be a serrated omnidirectional blade, facilitating saw-type cuts through a desired substrate. In an embodiment, the blade 710 and blade support 720 may be mounted on an intermediate finger (e.g., the ring, middle, or index fingers of the glove 700) which may facilitate making a generally flat reference surface for the blade 710 when the user makes a fist. In an embodiment, such positioning may facilitate improved accuracy and balance for long drag cuts using the blade 710.

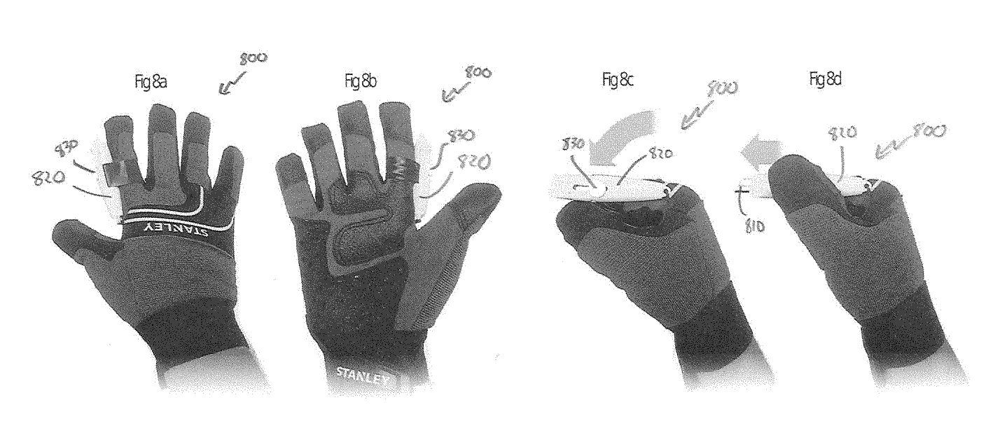

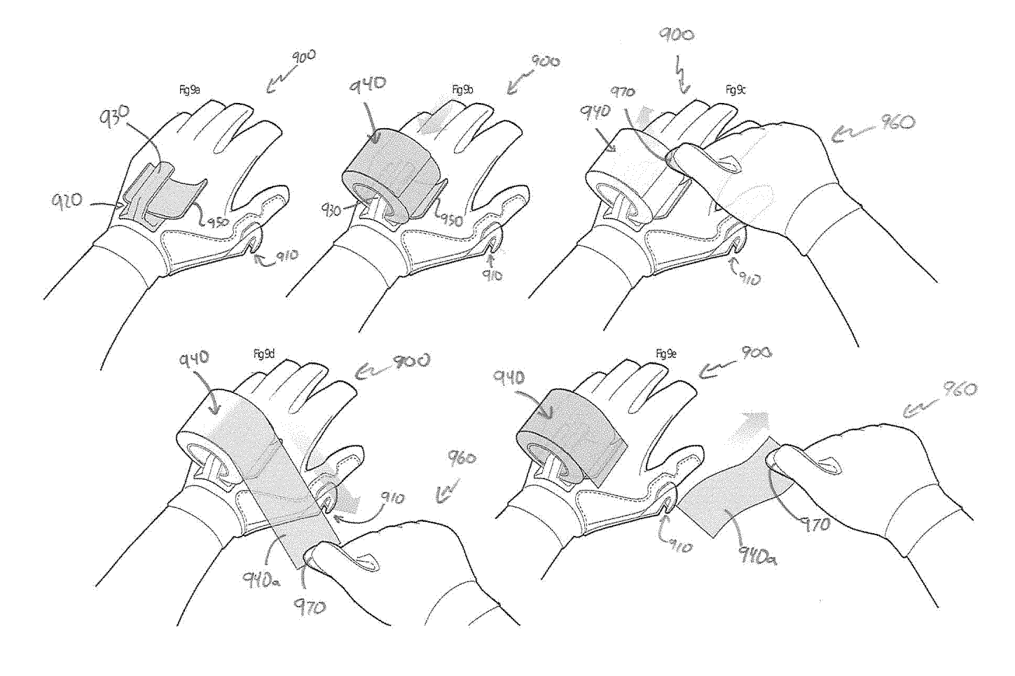

FIGS. 8a-d illustrate an embodiment of a box opening glove 800 having an index finger blade 810. As shown, in an embodiment the index finger blade 810 is retractable into or out of a housing 820 which may be oriented to extend along the length of the index finger (e.g., parallel to the index finger) when the index finger is extended, and generally remain parallel to the proximal phalanges (e.g., by being fixed to the glove 800 adjacent to the proximal phalanges) when the index finger is curled towards the palm. As shown, in an embodiment the housing 820 may include thereon an actuator 830 which may be positioned to be actuated by the thumb when the user's hand is closed into a fist (curling the fingers towards the palm). For example, in an embodiment the actuator 830 may be a sliding actuator, which may be engaged by the thumb sliding forward along the housing 820 to extend the blade 810 forward accordingly. In some embodiments, the blade 810 may be spring biased into a retracted position, such that maintaining a force on the actuator 830 may be needed to keep the blade 810 in an extended position. In some embodiments, the blade 810 may be replaceable (e.g., the housing 820 may be openable or a secondary actuator may be provided on the housing 820 so as to permit removing and replace the blade from a blade carriage coupled to the actuator 830, for example).

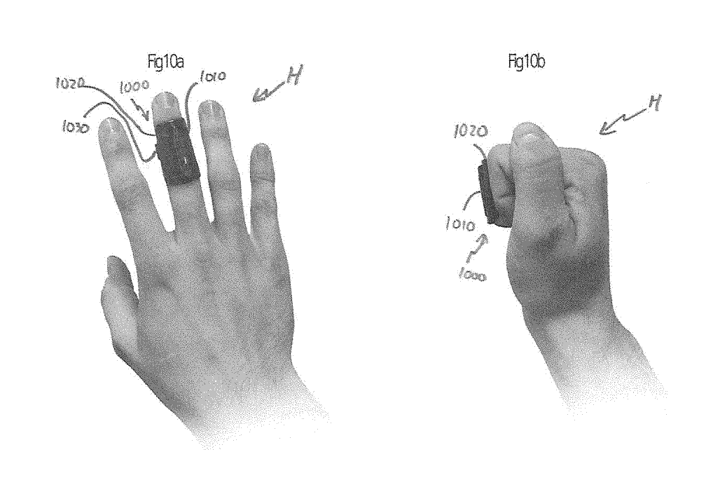

It may be appreciated that in some embodiments of the gloves disclosed herein, other package work features may be further included thereon. For example, FIGS. 9a-e show a glove 900. Similar to the glove 100 described above, in some embodiment the glove 900 includes a thumb blade 910 (e.g., similar to the thumb blade 110) and/or may have other features similar to those described in the various embodiments of glove 100. It may be appreciated that in other embodiments, features of other gloves disclosed herein may be integrated into the glove 900. As further shown, in an embodiment the glove 900 includes mounted thereon a tape mount 920. In an embodiment, the tape mount 920 includes an axle 930 (e.g., a rotatable spindle or a fixed post) which may receive thereon a roll of tape 940. As further shown, in some embodiments, the glove 900 may include (e.g., on the tape mount 920) a tape cutter 950, which may facilitate cutting a strip of tape 940a from the roll of tape 940 when the strip of tape 940a is extended therefrom. The tape cutter 950 may be of any appropriate construction or configuration, including having a serrated edge, for example.

As shown in FIGS. 9c-e, in some embodiments a glove 960 may include thereon a digit extension 970 which may facilitate initial separation of tape from the roll of tape 940 to allow separating the strip of tape 940a, such as is depicted in FIG. 9c. For example, in an embodiment the digit extension 970 may comprise a rigid or semi-rigid body protruding from an otherwise fabric or flexible configuration of the glove 960. By inserting the digit extension 970 between the terminal end and the prior wind of the roll of tape 940, the roll of tape 940 can be unwound creating the strip of tape 940a. It may be appreciated that in some embodiments sets of glove 900 and glove 960 may be provided together, so that functionality may complement one another. In some embodiments, the digit extension 970 may also be relatively sharpened so as to function as a tape splitter, or may have a cutting edge facilitating cutting packaging material or affixed tape as well as facilitating prying tape from the roll of tape 940.

For each of the embodiments of gloves disclosed herein, it may be appreciated that features may be positioned on either or both of left handed gloves and right handed gloves, so as to accommodate both left and right handed users. In some embodiments, features described as being implemented on specific digits (e.g., a particular finger or the thumb) may be implemented on other fingers or the thumb. It may be appreciated that in some embodiments, otherwise as disclosed herein, the gloves may be similar to those known in the art, and may be formed from one or more of fabric, leather, plastic, rubber, and similar components, which may be assembled via any appropriate mechanism, including stitched, glued, welded, molded, or so on.

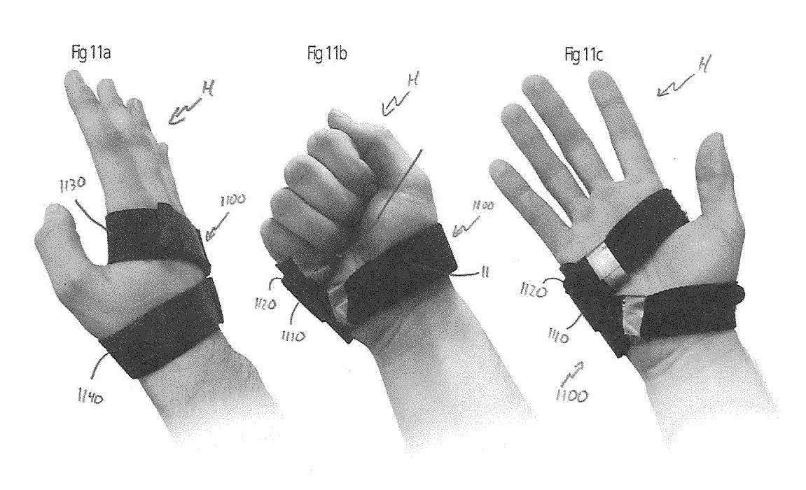

It may be appreciated that in some embodiments features disclosed herein may be provided on wearable structures outside of the context of gloves. For example, FIGS. 10a-b illustrate a box opening ring 1000 which may be functionally generally similar to the box opening glove 700. In particular, the box opening ring 1000 includes an interphalangeal joint blade 1010 mounted on a ring, which may be worn on a finger (e.g., the middle finger) of a hand H. The blade 1010 may be mounted on a generally rigid blade support 1020, which may have a ring or clip member 130 on an opposing face that a finger may be inserted into. The blade support 1020 may orient the blade 1010 at a desired angle. In an embodiment the blade 1010 may be a serrated omnidirectional blade, facilitating saw-type cuts through a desired substrate.

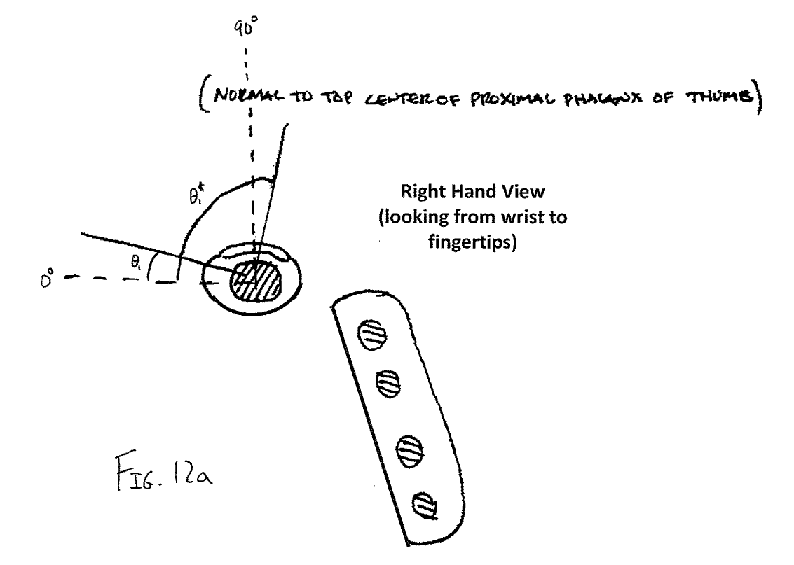

Similarly, as shown in FIGS. 11a-c, a hand brace 1100 (e.g., a hand wrap in the illustrated embodiment) which may be worn on the hand H, and may support on the hand H a blade 1110. As shown, the brace 1100 may be configured to orient the blade 1110 on the side of the palm. Such configuration may be effectuated, for example, by mounting the blade 1110 on a blade mount 1120, which may be shaped to match the contour of the side of the palm in some embodiments. In some embodiments, the brace 1100 may have attachment appurtenances (e.g., straps such as palm strap 1130 and wrist strap 1140 in the illustrated embodiment), which may further guide a user to position the blade mount 1120 in an intended location, such as on the side of the palm. As further shown, in an embodiment the blade 1110 may be a serrated blade, and may facilitate cutting omnidirectionally (e.g., through both pushing and pulling of the hand H). In some embodiments, the structure and features of the hand brace 1100 may be configured similarly to those of the glove 500. In an embodiment, the blade 1110 may be configured by the blade mount 1120 to be mounted at an angle relative to a plane parallel to the extension of the palm. It may be appreciated that in some embodiments, where at the hypothenar muscle extending away from the fingers along the plane is taken as 0°, and extending outward from the fingernails perpendicular to the plane is taken as 90°, it may be appreciated that the blade 1110 may be mounted approximately between −10° and 45°. In an embodiment, the blade 1110 may be mounted between approximately 25° and 45°. In an embodiment, the blade 1110 may be mounted at approximately 35°. Accordingly, in an embodiment, such as that illustrated, the blade 1110 may be configured by the shaping of the blade mount 1120 and/or the straps 1130 and 1140 to be positioned adjacent to the little finger of the hand H. In some embodiments, a further strap may be provided, e.g., alongside hook and loop fastener components, magnetic and metal components, or other appropriate mechanisms, to facilitate selectively covering the blade 1110 when use is not desired.

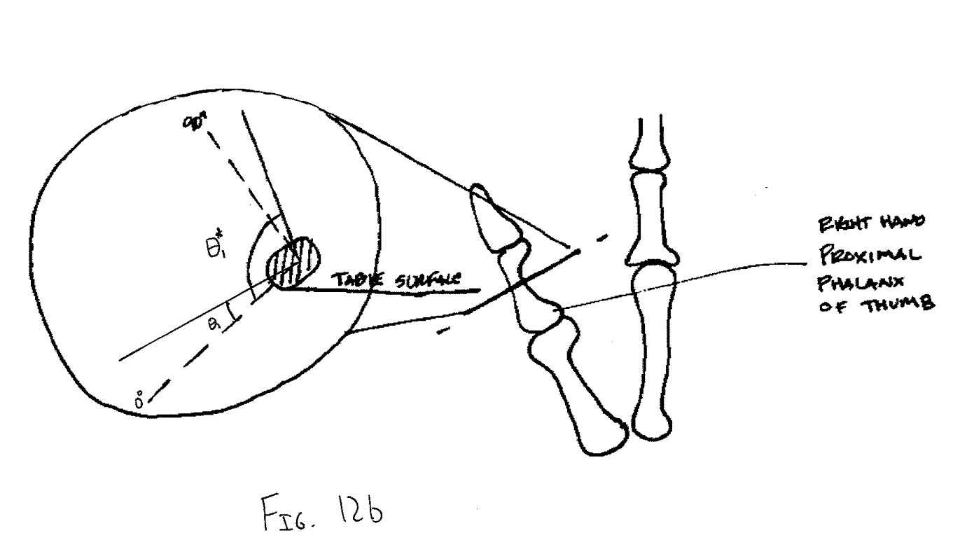

In various embodiments, the blades described herein may be formed of metal, plastic, ceramic, or any other appropriate material. Similarly, embodiments having an angled blade may be angled for directional cuts utilizing pushing or pulling motions in various embodiments. Blades may be omnidirectional, including serrated, having a curved or multifaceted configuration, or sharpened on multiple faces, such as opposing faces. Regarding the mounting of blades in the various embodiments disclosed herein, it may be appreciated that the blades may be oriented with reference to either a surface on which the hand would rest, or relative to anatomical features of a hand wearing the glove or other wearable implement. For example, FIG. 12a shows an illustrative view of where a thumb blade such as blade 110, blade 210, blade 320, or blade 910 may be mounted. While the illustrated view is depicted for the right hand, sectioned looking from the wrist to the fingertips (with the thumbnail, and the remainder of the fingers being shown schematically within the palm for positioning), it may be appreciated that the inverse may also be appropriate for a left hand worn wearable implement. As shown, taken with 90° being normal to the top center of the proximal phalanx of the thumb (e.g., if the hand were formed as a fist with the thumb on top), the blade may be mounted between θ₁ and θ₁* degrees. In an embodiment θ1=10° and θ₁*=105°. In a more specific embodiment, θ₁=25° and θ₁*=75°. In a still more specific embodiment, θ₁=30° and θ₁*=35°. As shown in FIG. 12b, when a hand (all fingers and the thumb) is resting on a table surface, the thumb is oriented at an angle relative to the other fingers. Accordingly, it may be appreciated that top normal to proximal phalanx of thumb may be at angle relative to normal to the table surface.

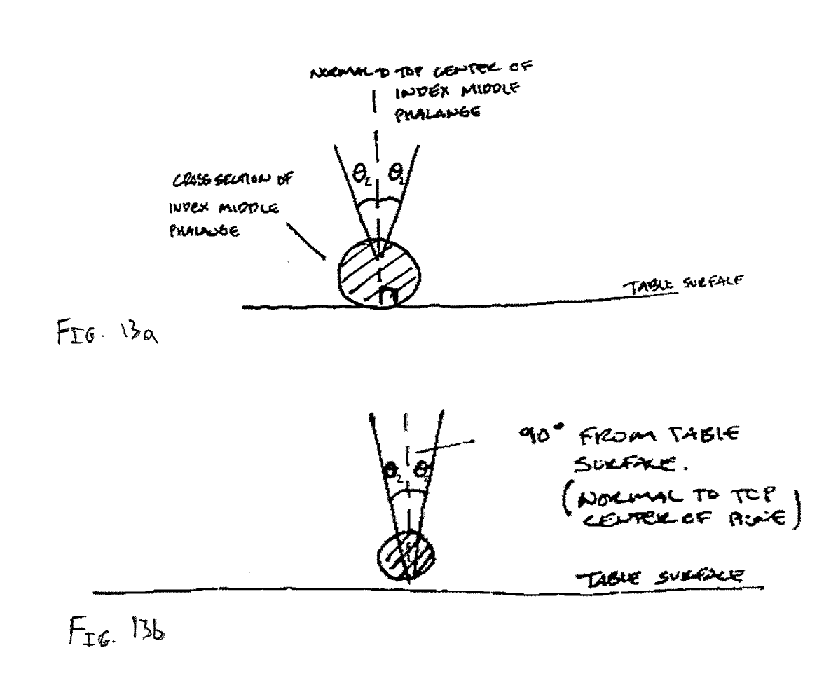

FIG. 13a and FIG. 13b illustrate potential angles for mounting a blade adjacent to or relative to a finger (e.g., the index finger), such as was described above with reference to blade 310, blade 710, or blade 1010, for example. It may be appreciated that the fingers (e.g., excluding the thumb) of the hand are generally oriented so that normal to a table that the hand is resting on and normal to the conventional top of the bones themselves are equivalent. Accordingly, normal to the top center of a finger such as the index middle phalange, as shown in FIG. 13a, appears similar to normal to a table surface that the hand is resting on, as show in FIG. 13b. Accordingly, regardless of the view, in some embodiments the blades such as blade 310 and blade 710 may generally extend in that generally common normal direction, or in a range of plus or minus θ₂ degrees. In some embodiments, θ₂ may be approximately 10°, such that the blade is mounted generally between 80-100° relative to a plane parallel to the table surface, or through the conventional top of the bones of the hand themselves.

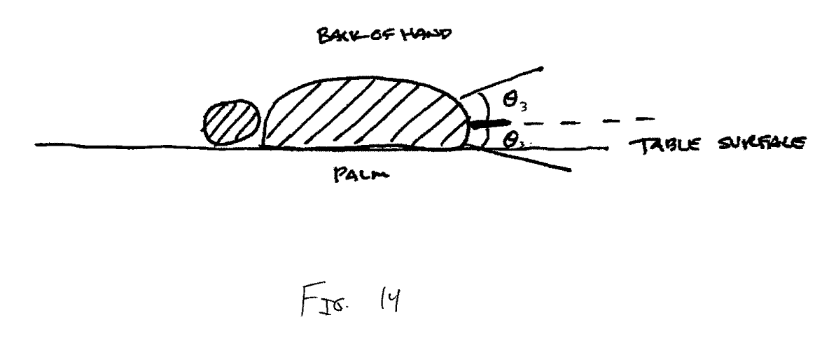

FIG. 14 illustrates potential angles for mounting a blade relative to the side of the palm adjacent to the little finger, such as was described above with reference to blade 410, blade 510, blade 610, or blade 1110, for example. As shown, in an embodiment the blade may be mounted generally parallel to a table surface which the palm is resting on (e.g., perpendicular to normal as described in FIG. 13a and FIG. 13b), or may be mounted θ₃ degrees offset from parallel (e.g., towards or away from the palm). For example, in an embodiment θ₃ may be approximately 10°.

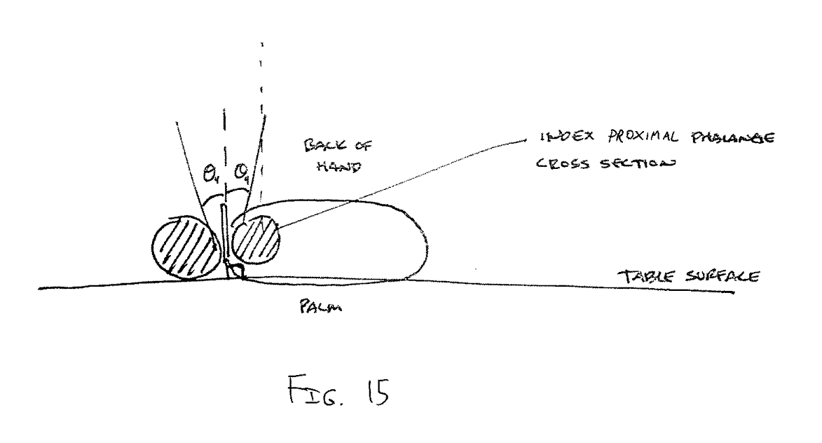

FIG. 15 illustrates how an index finger blade, such as that described above with reference to blade 810, may be oriented in some embodiments. As shown, in an embodiment the blade may be oriented normal to a reference table surface upon which the palm rests (e.g., parallel to normal to the phalanges of the index finger adjacent to the blade). In an embodiment, the blade may be oriented θ₄° offset from normal. In some embodiments, θ₄° may be approximately 10 degrees.

For the blade orientations described herein, it may be appreciated that in some embodiments the angles described may be made with reference to the angle of the spine of the blade, of which one or more edges relative to the spine may be sharpened be sharpened to form a tip.

It may be appreciated that the components described herein may be of different constructions or configurations, including but not limited to one or more being comprised of different material choices. For example, the components described herein may each be constructed from a variety of materials, including but not limited to one or more of fabrics, plastics, metals, rubbers, elastomers, or any other appropriate material choice. For example, in an embodiment one or more of the components (e.g., blades) may be formed of aluminum (e.g., machined aluminum), iron (e.g., steel), ceramic, or any other appropriate material. In some embodiments, the material choices may differ from component to component.

Although aspects of the invention have been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the exemplary disclosed embodiments. For example, it is to be understood that the present invention contemplates that, to the extent possible, one or more features of any embodiment can be combined with one or more features of any other embodiment.

What is claimed is:

1. A glove comprising:
a flexible area configured to be worn on a hand of a user, the flexible area being positioned to be secured on a palm of the hand;
a reinforced area coupled to the flexible area, the reinforced area configured to engage a thumb of the hand and extend towards the palm of the hand; and
a protrusion on the reinforced area, the protrusion comprising a blade;
wherein the protrusion orients the blade at an angle with respect to the reinforced area.

2. The glove of claim 1, wherein the blade is mounted on the protrusion as a drag blade, with a cutting surface of the blade being oriented towards an arm of the user.

3. The glove of claim 1, wherein the reinforced area is sewn into the flexible area.

4. The glove of claim 1, wherein the reinforced area is positioned to extend along a mid-joint of the thumb, distal from the palm.

5. The glove of claim 1, wherein relative to a reference plane defined by a thumbnail of a hand in the glove, where extending along the thumbnail away from the palm is 0° and extending normal to the thumbnail is 90°, the blade is mounted between approximately −10° and approximately 45°.

6. The glove of claim 5, wherein the blade is mounted between approximately 25° and 45°

7. The glove of claim 5, wherein the blade is mounted at approximately 35°.

8. The glove of claim 1, wherein the protrusion comprises a safety sheath limiting a size of substrate that may contact the blade.

9. The glove of claim 8, wherein the safety sheath is angled to guide substrate towards the blade.

10. The glove of claim 1, wherein the blade is serrated for omnidirectional cutting.

11. The glove of claim 1, further comprising a tape mount mounted to the flexible area, the tape mount having an axle configured to receive a roll of tape.

12. The glove of claim 11, further comprising a tape cutter coupled to the tape mount, and positioned for cutting a strip of tape from the roll of tape.

13. The glove of claim 11, wherein the tape cutter comprises a serrated edge.
